(19) United States
(12) Patent Application Publication
(10) Pub. No.: US 2008/0176476 A1
(43) Pub. Date: Jul. 24, 2008

(54) Method for fabricating organic light emitting display

(75) Inventors: Jung-Lung Huang, Miao-Li (TW); Chien-Ting Lai, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/788,968

(22) Filed: Apr. 23, 2007

(30) Foreign Application Priority Data
Apr. 21, 2006 (TW) 95114354

(51) Int. Cl. H01J 9/02

(52) U.S. Cl. 445/24

(57) ABSTRACT

An exemplary method for fabricating an organic light emitting display (OLED) (200) includes: providing a first substrate (210); providing moisture absorber (240) on the first substrate; processing the moisture absorber by using hydrogen plasma; providing a second substrate (220) having an organic light emitting unit (250) formed thereat; and attaching the first and second substrates together with a sealant, such that the moisture absorber and the organic light emitting unit are hermetically sealed between the first and second substrates, with the moisture absorber facing the organic light emitting unit. Because the moisture absorber is finished during the method for fabricating the OLED, and is sealed in the space between the first substrate and the second substrate soon after being finished, the moisture absorber is difficult to react with air. Thus, the OLED has improved quality.

### FIELD OF THE INVENTION

The present invention relates to methods for fabricating organic light emitting displays (OLEDs), and particularly to a method for fabricating an OLED that has moisture absorber.

### GENERAL BACKGROUND

Organic light emitting displays (OLEDs) provide high brightness and a wide viewing angle. Because OLEDs are self-luminous, they do not require back light, and can be effectively used even under relatively dark ambient conditions.

Referring to FIG. 5, a typical OLED 100 is shown. The OLED 100 includes a first substrate 110, a second substrate 120 opposite to the first substrate 110, sealant 130 formed at peripheries of opposite inner surfaces of the two substrates 110, 120, moisture absorber 140 formed on the inner surface of the first substrate 110, and an organic light emitting unit 150 formed on the inner surface of the second substrate 120. The first substrate 110, the second substrate 120, and the sealant 130 cooperatively define a sealed space accommodating the moisture absorber 140 and the organic light emitting unit 150.

The moisture absorber 140 conventionally includes an alkaline-earth metal oxide (MO), such as calcium oxide (CaO) or magnesia (MgO). Chemical activity of the moisture absorber 140 can be described according to the following formula:

MO+H₂O→M(OH)₂.

In general, the alkaline-earth metal oxide has low activity and low capability of moisture absorption. Therefore it is common for an alkaline-earth metal hydride (MH₂) to be used instead of an alkaline-earth metal oxide. An alkaline-earth metal hydride has high capability of moisture absorption.

Referring also to FIG. 6, this is a flowchart summarizing a conventional method for fabricating the OLED 100. The method includes: first, providing a first substrate 110 and cleaning the first substrate 110; second, providing moisture absorber 140 on the first substrate 110 in a nitrogen environment, the moisture absorber 140 including an alkaline-earth metal hydride such as calcium hydride (CaH₂) or magnesium hydride (MgH₂); third, providing a second substrate 120 having an organic light emitting unit 150 formed thereon; and fourth, attaching the first substrate 110 and the second substrate 120 together in a vacuum environment, with the moisture absorber 140 facing the organic light emitting unit 150. Thereby, the OLED 100 is obtained.

Generally, the above-described method is performed at a factory plant that mass manufactures OLEDs 100. The moisture absorber 140 (including the alkaline-earth metal hydride) is provided to the factory as a raw material. That is, the moisture absorber 140 is a discrete product, which is prepared and packaged elsewhere, and then transported to the factory plant and stored prior to use. Because the alkaline-earth metal hydride has high chemical activity, it is liable to react with air during packaging, transportation and storage of the moisture absorber 140. Thus, the moisture absorption capability of the moisture absorber 140 may be diminished by the time it is finally utilized in manufacturing the OLEDs 100. Accordingly, the OLEDs 100 may have impaired quality.

Therefore, a new method for fabricating an OLED that can overcome the above-described problems is desired.

### SUMMARY

In one preferred embodiment, a method for fabricating an organic light emitting display includes: providing a first substrate; providing moisture absorber on the first substrate; processing the moisture absorber by using hydrogen plasma; providing a second substrate having an organic light emitting unit formed thereat; and attaching the first and second substrates together with a sealant, such that the moisture absorber and the organic light emitting unit are hermetically sealed between the first and second substrates, with the moisture absorber facing the organic light emitting unit.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is a side, cross-sectional view of an exemplary organic light emitting display made according to any of various embodiments of the present invention.

FIG. 2 is a flowchart summarizing a method for fabricating the organic light emitting display of FIG. 1 according to a first embodiment of the present invention.

FIG. 3 is a flowchart summarizing a method for fabricating the organic light emitting display of FIG. 1 according to a second embodiment of the present invention.

FIG. 4 is a flowchart summarizing a method for fabricating an alternative kind of organic light emitting display, according to a third embodiment of the present invention.

FIG. 5 is a side, cross-sectional view of a conventional organic light emitting display.

FIG. 6 is a flowchart summarizing a method for fabricating the organic light emitting display of FIG. 5.

### DETAILED DESCRIPTION OF PREFERRED EMBODIMENTS

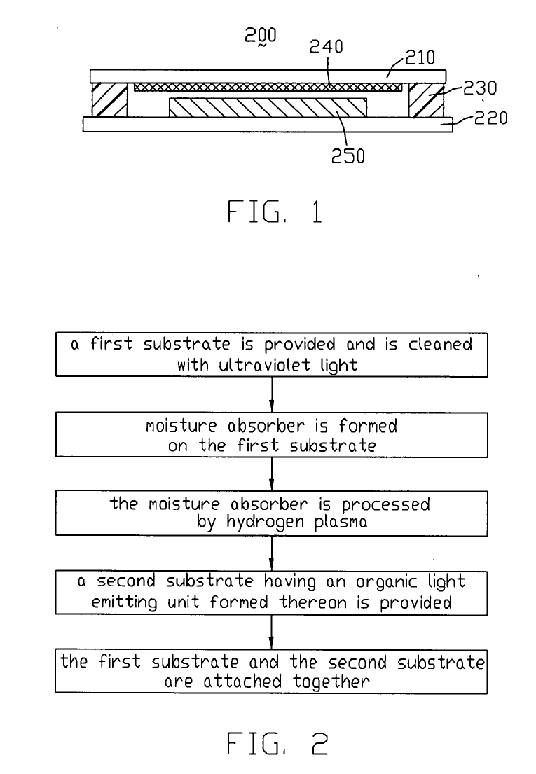

Referring to FIG. 1, an exemplary OLED 200 made according to any of various embodiments of the present invention is shown. The OLED 200 includes a first substrate 210, a second substrate 220 opposite to the first substrate 210, sealant 230 formed at peripheries of opposite inner surfaces of the two substrates 210, 220, moisture absorber 240 formed on the inner surface of the first substrate 210, and an organic light emitting unit 250 formed on the inner surface of the second substrate 220. The first substrate 210, the second substrate 220, and the sealant 230 cooperatively define a sealed space accommodating the moisture absorber 240 and the organic light emitting unit 250. The first and second substrates 210, 220 can be made of a transparent material, such as glass or acryl. The moisture absorber 240 can be formed on the inner surface of the first substrate 210 by a deposition method, a painting method, a coating method, or any other suitable method.

Referring also to FIG. 2, this is a flowchart summarizing a method for fabricating the OLED 200 according to a first embodiment of the present invention. The method includes the following steps:

First, a first substrate 210 is provided. The first substrate 210 is cleaned with ultraviolet light irradiation.

Second, moisture absorber 240 is formed on the first substrate 210 in a nitrogen environment. The moisture absorber 240 includes an alkaline-earth metal oxide (MO) such as calcium oxide (CaO) or magnesia (MgO).

Third, the moisture absorber 240 is processed by hydrogen plasma in a vacuum environment, such that the alkaline-earth metal oxide is transformed into an alkaline-earth metal hydride (MH₂). Chemical action involved in this processing step can be described according to the following formulas:

MO+H⁺→MH⁻+O

MH⁻+H⁺→MH₂.

Fourth, a second substrate 220 having an organic light emitting unit 250 formed thereon is provided.

Fifth, the first substrate 210 and the second substrate 220 are attached together by sealant 230 in a vacuum environment, with the moisture absorber 240 facing the organic light emitting unit 250. Thus the first and second substrates 210, 220 are hermetically sealed together by the sealant 230, whereby the OLED 200 is obtained.

In the above-described method, the moisture absorber 240 (including the alkaline-earth metal hydride) in finished form is obtained during the fabricating of the OLED 200. Immediately after the finished moisture absorber 240 is obtained, , the second substrate 220 and the sealant 250 are provided, and the moisture absorber 240 is sealed in a hermetic space defined between the first and second substrates 210, 220. Therefore the moisture absorber 240 undergoes little or no reaction with air, and is preserved substantially intact in the space. Thus the moisture absorber 240 is fully functional, so that the OLED 200 can have improved quality of output light.

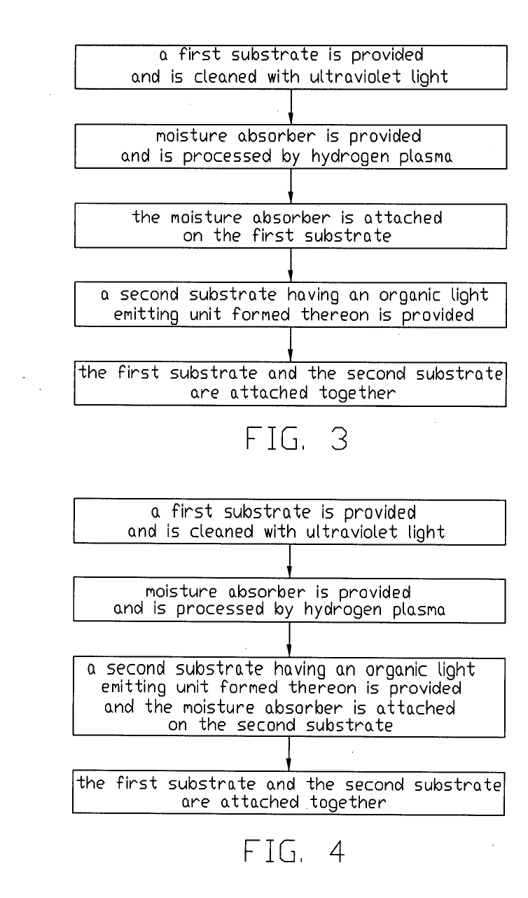

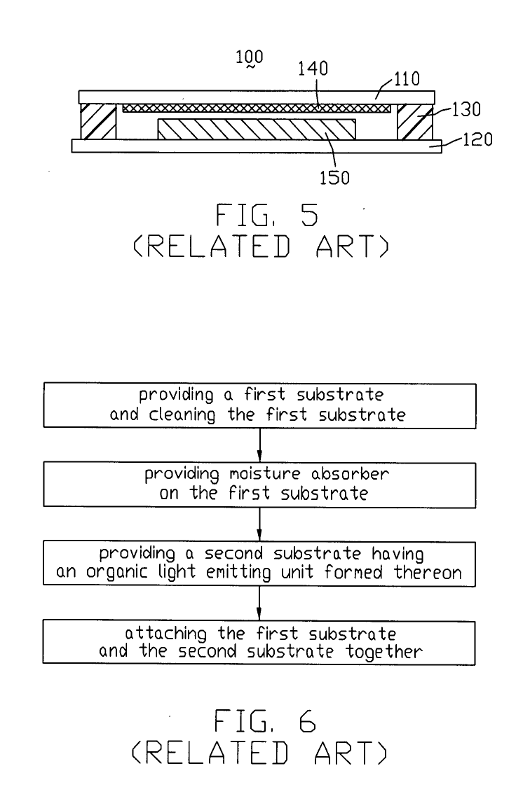

Referring also to FIG. 3, this is a flowchart summarizing a method for fabricating the OLED 200 according to a second embodiment of the present invention. The method includes the following steps:

First, a first substrate 210 is provided. The first substrate 210 is cleaned with ultraviolet light irradiation.

Second, moisture absorber 240 is provided. The moisture absorber 240 includes an alkaline-earth metal oxide (MO) such as calcium oxide (CaO) or magnesia (MgO). The moisture absorber 240 is processed by hydrogen plasma in a vacuum environment, such that the alkaline-earth metal oxide is transformed into an alkaline-earth metal hydride (MH₂).

Third, the processed moisture absorber 240 is attached on the first substrate 210 in a nitrogen environment.

Fourth, a second substrate 220 having an organic light emitting unit 250 formed thereon is provided.

Fifth, the first substrate 210 and the second substrate 220 are attached together by sealant 230 in a vacuum environment, with the moisture absorber 240 facing the organic light emitting unit 250. Thus the first and second substrates 210, 220 are hermetically sealed by the sealant 230, whereby the OLED 200 is obtained.

Referring also to FIG. 4, this is a flowchart summarizing a method for fabricating an alternative kind of OLED, according to a third embodiment of the present invention. The method includes the following steps:

First, a first substrate is provided. The first substrate is cleaned with ultraviolet light irradiation.

Second, moisture absorber is provided. The moisture absorber includes an alkaline-earth metal oxide (MO) such as calcium oxide (CaO) or magnesia (MgO). The moisture absorber is processed by hydrogen plasma in a vacuum environment, such that the alkaline-earth metal oxide is transformed into an alkaline-earth metal hydride (MH₂).

Third, a second substrate having an organic light emitting unit formed thereon is provided. The processed moisture absorber is attached on the second substrate and covers and surrounds the organic light emitting unit.

Fourth, the first substrate and the second substrate are attached together by sealant in a vacuum environment. Thus the first and second substrates are hermetically sealed by the sealant, whereby the OLED is obtained.

Further or alternative embodiments may include the following. In one example, the moisture absorber is processed by hydrogen plasma in a hydrogen gas environment.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A method for fabricating an organic light emitting display (OLED), the method comprising:
providing a first substrate;
providing moisture absorber on the first substrate;
processing the moisture absorber by using hydrogen plasma;
providing a second substrate having an organic light emitting unit formed thereat; and
attaching the first and second substrates together with a sealant, such that the moisture absorber and the organic light emitting unit are hermetically sealed between the first and second substrates, with the moisture absorber facing the organic light emitting unit.

2. The method as claimed in claim 1, further comprising cleaning the first substrate with ultraviolet light after providing the first substrate.

3. The method as claimed in claim 1, wherein the moisture absorber is attached on the first substrate in a nitrogen environment.

4. The method as claimed in claim 1, wherein the moisture absorber is processed in a vacuum environment.

5. The method as claimed in claim 1, wherein the moisture is processed in an atmospheric hydrogen environment.

6. The method as claimed in claim 1, wherein the first and second substrates are made of transparent material.

7. The method as claimed in claim 6, wherein the first and second substrates are made of glass or acryl.

8. The method as claimed in claim 1, wherein the moisture absorber comprises alkaline-earth metal oxide (MO).

9. The method as claimed in claim 8, wherein the moisture absorber comprises at least one material selected from the group consisting of calcium oxide (CaO) or magnesia (MgO).

10. The method as claimed in claim 8, wherein action principle of the processing step comprises the following formulas: MO+H⁺→MH⁻+O, MH⁻+H⁺→MH₂.

11. A method for fabricating an organic light emitting display (OLED), the method comprising:
providing a first substrate;
providing moisture absorber and processing the moisture absorber by using hydrogen plasma;
attaching the moisture absorber on the first substrate;
providing a second substrate having an organic light emitting unit formed thereat; and
attaching the first and second substrate together with a sealant, such that the moisture absorber and the organic light emitting unit are hermetically sealed between the first and second substrates, with the moisture absorber facing the organic light emitting unit.

12. The method as claimed in claim 11, further comprising cleaning the first substrate with ultraviolet light after providing the first substrate.

13. The method as claimed in claim 11, wherein the moisture absorber is processed in a vacuum environment.

14. The method as claimed in claim 11, wherein the moisture is processed in an atmospheric hydrogen environment.

15. The method as claimed in claim 11, wherein the first and second substrates are made of transparent material.

16. The method as claimed in claim 15, wherein the first and second substrates are made of glass or acryl.

17. The method as claimed in claim 11, wherein the moisture absorber comprises alkaline-earth metal oxide (MO).

18. The method as claimed in claim 17, wherein the moisture absorber comprises at least one material selected from the group consisting of calcium oxide (CaO) or magnesia (MgO).

19. The method as claimed in claim 17, wherein action principle of the processing step comprises the following formulas: MO+H⁺→MH⁻+O, MH⁻+H⁺→MH₂.

20. A method for fabricating an organic light emitting display (OLED), the method comprising:
providing a first substrate;
providing moisture absorber and processing the moisture absorber by hydrogen plasma;
providing a second substrate having an organic light emitting unit formed thereat and attaching the moisture absorber on the second substrate, the moisture absorber covering and surrounding the organic light emitting unit; and
attaching the first and second substrates together with a sealant, such that the moisture absorber and the organic light emitting unit are hermetically sealed between the first and second substrates.
